(19) United States
(12) Patent Application Publication
(10) Pub. No.: US 2015/0210174 A1
(43) Pub. Date: Jul. 30, 2015

(54) Charging System And Method For Electronically Charging A Motor Vehicle

(71) Applicant: KUKA Roboter GmbH, Augsburg (DE)

(72) Inventor: Norbert Settele, Willprechtszell (DE)

(73) Assignee: KUKA ROBOTER GMBH, Augsburg (DE)

(21) Appl. No.: 14/417,360

(22) PCT Filed: Jul. 25, 2013
(86) PCT No.: PCT/EP2013/002215

§ 371 Date: Jan. 26, 2015

(30) Foreign Application Priority Data
Jul. 27, 2012 (DE) 10 2012 014 936.0

(51) Int. Cl. B60L 11/18

(52) U.S. Cl. CPC B60L 11/1816; B60L 11/1827

(57) ABSTRACT

The invention relates to a charging system for a motor vehicle, in particular a passenger car (2), provided with a robot (1) having a control means (1.1), a force detecting means (5), and a plug (4.1) fastened to the robot, configured to establish a detachable plug connection with the mating plug (4.2) on the vehicle side for charging an electric energy store of the motor vehicle, wherein the control means is configured to communicate with the force detecting means, and to connect the robot-guided plug to the mating plug based on a force detected by the force detecting means.

The present invention relates to a charging system and a method for electrically charging a motor vehicle, in particular a passenger car, and a computer program product for executing a method of this type.

A charging system and a method for charging a power source for a transport means having a robot unit, which can move, in particular, in three axes, is known from DE 10 2009 006 982 A1, which automatically connects a charging device to an interface on the power source. A slight tilting over the vertical axis of coupling for the power supply when it is being plugged in can be compensated for thereby, and/or the coupling is not affected by a twisting thereof.

A passive tolerance compensation of this type, in particular taking into account the, in part, large deviations in position that occur in practice when a motor vehicle is positioned at the charging system, on one hand, and the sensitivity of electrical plug-in connections on the other hand, can lead to increased wear to the plug-in connection.

The object of the present invention is to improve the charging of an electric motor vehicle, in particular a passenger car having an electrical power storage unit for supplying power to a drive unit.

This objective is achieved by a charging system having the features of Claim 1. Claim 9 places a method for the electrical charging of a motor vehicle by means of such a charging system under protection, Claim 14 places a computer program product, in particular a data storage medium, or a storage medium, respectively, for executing a method of this type, under protection. The dependent claims relate to advantageous further developments.

A charging system for charging an electric motor vehicle, in particular a passenger car, having an electric power storage unit for supplying power to a drive unit, exhibits a robot and a control means for controlling this robot, wherein, for a more compact depiction, controlling as set forth in the present invention can, in general, also comprise regulating, i.e. the output of actuating variables based on returned actual values. Accordingly, in one embodiment, the control means can exhibit one or more regulators, in particular at least one power regulator, or power regulation, respectively, as shall be explained below.

A means, as set forth in the present invention, can be designed in terms of hard and/or software technology, in particular a processing unit, in particular a microprocessor unit (CPU), in particular a digital processor, preferably connected to a storage and/or bus system, such that it can transmit data, or signals, respectively, and/or can have one or more programs or program modules. The CPU can be designed to process commands, which are implemented as a program installed in a storage system, to record input signals from a data bus, and/or to transmit output signals to a data bus. A storage system can have one or more, in particular different, storage media, in particular optical, magnetic, solid state and/or other non-volatile media. The program can be created such that it embodies the method described herein, or is capable of executing said method, such that the CPU can execute the steps of such a method, and can thus, in particular, control the robot.

In one embodiment, the robot can have one or more, in particular at least six or seven, axes. A six-axis robot can advantageously—in the scope of its structural limiting conditions—depict arbitrary positions and orientations of its end effector, and thus approach end positions that, in particular, are difficult to access and/or differ, and/or follow paths with predefined orientations. A redundant, seven-axis, or multiple-axis robot can advantageously resolve, or avoid, respectively, singular poses, and adapt, additionally, even more effectively to different environmental conditions, in particular obstacles in the workspace. In one embodiment, the robot is an articulated robot, having one or more, in particular at least six, pivot joints, wherein, in a further development, a second axis following a base, or fundamental axis, is oriented perpendicular to this axis, and a third axis following a second axis is parallel thereto, and/or a third, fourth and/or fifth axis can be oriented perpendicular to a preceding axis. This configuration has proven to be particularly advantageous for the present application. The robot can be stationary, in particular it can be attached to a floor, a wall, or a ceiling, or it can be mobile, in particular it can travel on wheels or rails.

A plug is releasably, or replaceably, respectively, or permanently attached to the robot, which is configured to establish a releasable plug-in connection with a mating plug on the vehicle, for charging an electrical power storage unit of the motor vehicle. In one embodiment, the electrical plug-in connection can be a plug-in connection according to SAE J1772-2009, VDE-AR-E 2623-2-2 or IEC 62196-3 and/or type 1, type 2, or type 3 and/or a combination plug-in connection, in particular a combined DC and AC plug-in connection, or a plug-in connection that is compatible thereto. In a further development, the charging system has various plugs for a releasable connection with different mating plugs. Various plugs can be attached collectively to the robot in a further development, and be implemented by the robot selectively, in particular by means of reorienting a robot hand. Additionally or alternatively, the charging system can also have a plug magazine, from which the robot can selectively remove and guide various plugs. A plug and mating plug as set forth in the present invention indicate the two partners of a plug-in connection, which form the electrical plug-in connection when they are plugged together in a form-locking and/or friction-locking manner. In particular, a robot-guided plug designed as a plug (“male connector”) can be inserted in the mating plug on the vehicle, designed as a socket (“female connector”).

The robot has a force detection means, with which the control means communicates. For a more compact depiction, a force as set forth in the present invention, can in general also indicate, or comprise, respectively, numerous forces, in particular anti-parallel pairs of forces, i.e. torques. Accordingly, the force detection means can be, in particular, a multi-axis force detection means, for detecting forces in one, two, or three, in particular Cartesian or linear axes, and/or to detect torques in one, two or three axes of rotation. Advantageously, by means of a multi-axis force detection means, thrust forces, in particular, in a plane perpendicular to a plug-in or connection direction for the plug-in connection, tension and/or compression forces in the plug-in direction, torsional torques about the plug-in direction, and/or turning torques about one or two axes perpendicular to the plug-in direction, can be detected.

In one embodiment, the force detection means has an, in particular, multiple, preferably six-axis, force and/or torque sensor. This can be disposed, in a further development, between the robot-guided plug and the robot, or a flange on the robot, respectively, in order to detect reaction forces that act on the plug. A force and/or torque sensor of this type can communicate with the control means in a wireless manner, or by means of a cable connection.

Additionally or alternatively, the force detection means can have one or more force sensors on axes, in particular joints and/or drives, in particular gearing mechanisms, of the robot, in particular, torque sensors on pivot joint drive motors and/or gearing mechanisms. Reaction forces acting on the plug can likewise be detected by this means, in particular in a model-supported manner. As a result, a separate force and/or torque sensor on the flange of the robot, in particular, can be eliminated.

In order to not interfere with a tank opening in a body of a motor vehicle that is to be charged, a force and/or torque sensor, in particular having a substantially cylindrical shape, can exhibit a diameter that is smaller than this tank opening. At the same time, an extension can be disposed between the plug and the force and/or torque sensor, in particular a spacing sleeve, in order to facilitate an insertion of the plug in the tank opening.

According to one aspect of the present invention, the control means controls the robot such that it connects the robot-guided plug to the mating plug, or is configured, in particular by means of a program, for doing so. In doing so, the robot is controlled on the basis of the force determined by the force detection means, in particular, the robot is force-regulated. The force regulation can occur in one or more axes of the robot and/or in one or more spatial axes. In particular, the robot can be controlled in a force-regulated manner in one or more Cartesian axes and/or axes of rotation in the workspace, preferably in the plug-in or connection direction of the electrical plug-in connection, or the robot-guided plug and/or perpendicular thereto and/or about one or more axes of rotation that are perpendicular to the plug-in direction. The force regulation can occur as an alternative to a positioning regulation in the corresponding axes, or directions, respectively, or can be superimposed thereon.

Thus, in one embodiment, a plug-in movement can be commanded in the plug-in direction, i.e. it can be position-regulated in a Cartesian spatial axis. This positional regulation can be superimposed on a force regulation. In particular, a plug-in movement can be interrupted or modified if a force detected by the force detection means, which acts on the plug, exceeds a threshold value, in particular a predefinable threshold value. The plug can deviate in a force-regulated manner in one or more directions, or a plane perpendicular to the plug-in movement or plug-in direction, and thus compensate for an offset, or a tolerance, respectively, in this direction. Additionally or alternatively, the plug can deviate in a force-regulated manner about one or more axes of rotation, in particular, it can tilt about one or more axes perpendicular to the plug-in direction, and thus compensate for an orientation offset, or an orientation tolerance. A force regulation of this type, perpendicular to the plug-in direction, can be superimposed on a positional regulation, in order to depict a base, or starting, orientation and/or positioning of the plug.

By determining a force that acts during, or through, the connecting of the robot-guided plug with the mating plug on the vehicle, and by controlling the robot for connecting the robot-guided plug with the mating plug on the basis of this force determined by the force detection means, in particular to make the connection such that it is force-regulated in one or more axes, the load to the electrical plug-in connection can advantageously be reduced, and thus, in particular, the reliability and/or the durability thereof can be increased.

A force regulation can be designed, in particular, such that the robot, or the robot-guided plug, compensates for a force acting thereon during the connection of the plug with the mating plug. The control means can thus control the robot, in particular, such that it displaces the plug, in particular in a plane perpendicular to the plug-in, or connection, direction, in the direction of a force acting on it. A target value for a force regulation can be, in particular substantially, zero, i.e. the regulation target value for a plug-in, or connection that is, at least substantially, free of obstructing forces.

A force-regulated compensation of position and/or orientation deviations between the robot-guided plug and the mating plug on the vehicle, as is proposed according to one aspect of the present invention, is suitable in particular for compensating for smaller deviations.

For this reason it is proposed in accordance with one embodiment of the present invention that the robot, or the robot-guided plug, respectively, be pre-positioned prior to the actual plugging in, or connecting, respectively. In order to compensate for deviations in the position and/or orientation thereby between a theoretical, or target position of the mating plug and its actual position, which can arise in particular when the charging system is moved into position and when the motor vehicle is parked, first an actual position, i.e. the position and/or orientation, of the mating plug is determined. The charging system has a position detection means for this in one embodiment. In a further development, this can include an image recording and processing means, in particular a camera, preferably a CCD camera, and a pattern recognition means, which is configured to identify the mating plug in a camera image. The control means can then pre-position the robot-guided plug, at least substantially, such that it is aligned with the actual position of the mating plug. Additionally or alternatively, the positioning detection means can also have a distance detection means for determining a distance to a motor vehicle, in particular the mating plug on the vehicle. The control means can then pre-position the robot-guided plug at a predefined distance to the mating plug. Subsequently the robot-guided plugging-in of the plug can occur on the basis of a force acting thereon, determined by the force detection means.

The position detection means can be robot-guided and, for this purpose, be attached permanently, or releasably, or replaceably, respectively, to the robot. In one embodiment the robot can first guide the position detection means and determine the position of the mating plug, and subsequently replace the position detection means with the plug, in order to connect the plug to the mating plug. In another embodiment, the position detection means and the plug can be attached to the robot at the same time, or the robot can guide the position detection means and the plug at the same time, in order to eliminate this replacement effort. The position detection means can be configured thereby to detect a region in the plug-in direction in front of the plug. In this manner, the robot can pre-position the plug on the basis of the position detection means, and subsequently connect it to the mating plug, without changing its pose, and/or monitor the plug-in, or connection procedure and/or the plug-in connection. At the same time, the position detection means can be configured to detect another region, i.e. a region that does not lie in the plug-in direction in front of the plug, in particular a region that lies adjacent to a region that lies in the plug-in direction in front of the plug. This can be beneficial, in particular, with regard to reducing the risk of damage to, or interfering with, the position detection means during the plugging-in. The robot can then first orient the position detection means toward the mating plug, determine its position, and subsequently pre-position the robot-guided plug, by means of repositioning, in particular, a robot hand. At the same time, the position detection means can, however, be disposed independently of the robot, in particular, it can be stationary, or more independently.

In addition, or alternatively, to a position detection means, the robot can have a gripper for opening and/or closing a tank lid on a tank opening, in order to open the tank lid covering the mating plug prior to connecting the plug and mating plug, and/or to close the tank lid after releasing, or separating the plug and mating plug. The gripper can be, in particular, a magnetic and/or vacuum gripper, and in a further development, can be positioned, in place of the robot-guided plug, in front of the mating plug, or the tank lid covering the mating plug, in particular by reorienting a robot hand. For this, the position detection means can be configured to detect the position of the tank lid. Additionally or alternatively, the tank lid can be released and/or opened by a driver.

In one embodiment, the force sensor can determine the force not only during the connecting, but also during the releasing and/or during the charging, or when the plug-in connection is engaged, and this force, determined by the force sensor, can be stored and/or, in particular during and/or after the charging, or when on- and/or offline, this force can be evaluated. A corresponding storage and/or evaluation means can communicate with the control means, or be integrated therein, in particular as a corresponding processing unit and/or as a corresponding program or program module.

As a result, the connecting procedure can be monitored and/or evaluated in a further development, in particular to determine whether a sufficient plug-in force has been achieved, and thus, whether or not a plug-in connection is secure to the desired extent. Additionally or alternatively to such an evaluation of the plug-in connection, by storing and/or evaluating, in particular, numerous connecting procedures, a change, in particular wear, to the plug and/or mating plug can be detected, for example when the detected force is different for different connecting procedures, in particular, when this force increases or decreases. Accordingly, the plug-in connection can be adjusted, for example, by increasing or reducing the target forces in the force regulation, for example.

Additionally or alternatively, the storage and/or evaluation means can be configured to determine, store and/or evaluate an electrical parameter, in particular an electrical resistance, of the plug-in connection. In one embodiment, wear to the plug-in connection can be determined, in particular by the storage and/or evaluation means configured for this purpose, in particular on the basis of the force and/or electrical parameter detected, stored and/or evaluated during the connecting, releasing and/or during the charging, or when the plug-in connection is engaged, respectively, in particular during and/or after the charging, or when on- and/or offline, respectively, and this wear can be indicated to the driver in a further development. In a further development, a remaining service life of the plug-in connection, in particular a number of possible plug-in cycles, can be estimated and/or indicated, in particular, displayed, in particular by the storage and/or evaluation means configured for this purpose.

Additionally or alternatively, a charging, or filling procedure, respectively, can be evaluated, in particular by the storage and/or evaluation means configured for this purpose. Thus, for example, a time, during which the plug-in connection is engaged, and/or an electrical parameter, can be stored, and can be further processed in order to determine a charging quantity, in particular a consumed, or received quantity of power. Additionally or alternatively, the mating plug and/or the motor vehicle that is to be charged can be identified, in particular by the storage and/or evaluation means configured for this purpose, in order, for example, to authorize, allocate and/or record a charging.

Additionally or alternatively, by storing and/or evaluating the detected force, a target path for the robot, or the robot-guided plug can be adjusted, or, respectively, the control means or the storage and/or evaluation means can adjust a target path on the basis of a stored and/or evaluated force, in particular, it can modify this target path. Thus, in particular a target path for future connecting procedures, i.e. a connecting path, can be adapted on the basis of previous connecting procedures, by means, for example, of an adaptive path planning and/or adaptive control, in particular an artificial neural network. If, for example, the robot is made to deviate in a direction in a force-regulated manner during the plugging-in, this deviation can be taken into account in the planning of target path for removing the plug, and can be followed. If, for example, the force-regulated charging position that is attained for the robot-guided plug, at which this plug is connected to the mating plug, always deviates in a specific direction from the pre-positioning determined on the basis of the position detection means, this pre-positioning, or the charging position, respectively, can be adjusted accordingly.

In particular in the case of a malfunction, a relative movement of the motor vehicle in relation to the robot can occur during the charging procedure, i.e. with an engaged plug-in connection. Smaller relative movements in particular can be compensated for by the robot in a force-regulated manner, in that the robot adjusts the charging position, or the position of the robot-guided plug during the charging, or when the electric plug-in connection is engaged, respectively, on the basis of an evaluation of the force detected during the charging procedure. In general, in one embodiment of the present invention, the force during the connecting and/or releasing of the plug-in connection and/or during the charging procedure, or when the plug-in connection is engaged, respectively, can thus be detected, stored and/or evaluated. Additionally or alternatively, in order to react, in particular, to larger relative movements, a safety coupling can be disposed between the plug and the robot, in particular between the plug and a force and/or torque sensor, or between a force and/or torque sensor and the robot, or a robot flange, respectively. A safety coupling is understood in the present case to mean a connection, which disengages when a predefined force has been exceeded. The safety coupling can be designed as a passive element, having permanent magnets or spring-loaded catches, for example, which disengage when their attractive force, or tension force, respectively, is exceeded. At the same time, the safety coupling can also be designed as an active element, having an electromagnet, or an electrically actuated catch, for example, which can be opened by the control means on the basis of a force detected by the force detection means, in particular when this force exceeds a predefinable force.

In one embodiment a charging of the power storage unit is executed dependently on a release by the control means. In particular, it can be provided in a further development that the plug is only provided with current for charging the power storage unit if, or as long as, the plug-in connection is engaged and/or the force detection means detects that a force in the plug-in direction exceeds a predefined value and/or a force in another direction, in particular perpendicular thereto, lies below a predefined value. In this manner it is possible to ensure that with a shearing force that acts on the plug-in connection during the charging procedure and attempts to release this connection, the plug is not provided with current, or is only provided with current as long as the plug presses against the mating plug with sufficient force. The control means can make the release, additionally or alternatively dependent on other conditions, such as a visual monitoring by means of the position detection means, the pausing, in particular the stopping, of the robot in a predefined charging pose, or a safety region surrounding it, or suchlike.

Further advantages and features can be derived from the dependent claims and the embodiment examples. Shown in the figures are, in part schematically:

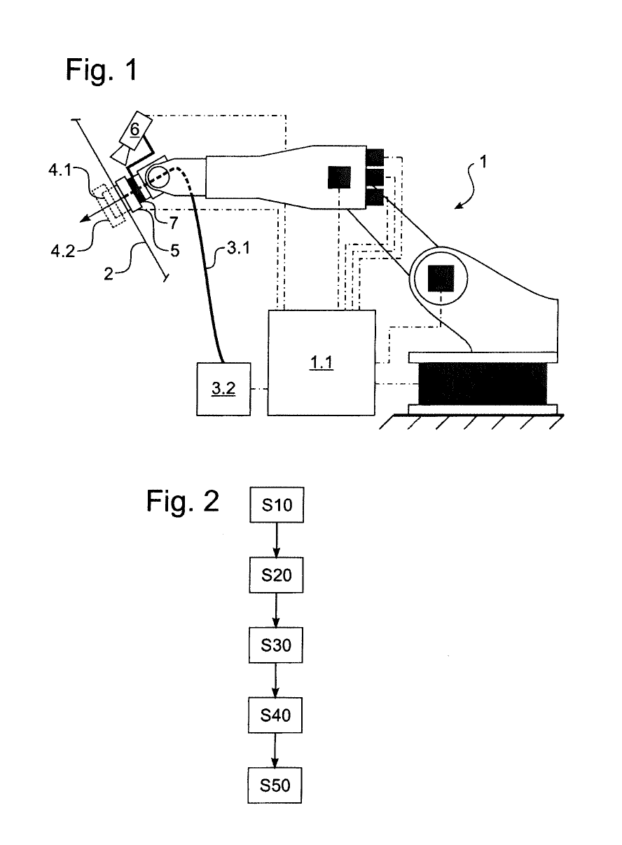

FIG. 1: a charging system according to one embodiment of the present invention; and

FIG. 2: a method according to one embodiment of the present invention.

FIG. 1 shows a charging system for a passenger car 2 with an electrical power storage unit for supplying energy to an electric vehicle drive, which exhibits a socket-like mating plug 4.2, which is disposed, counter-sunk in a tank opening in the body of the passenger car, as is indicated in part in FIG. 1.

The charging system has a stationary, or, in a variation not shown, mobile robot 1 with a control means 1.1 in the form of a control unit having programs running thereon. The robot is designed as a six-axis articulated robot having a vertical base axis, a second and third rotational axis perpendicular thereto, for a link arm in relation to a horizontal rotating table, or a robot hand in relation to the link arm, as well as a fourth, fifth and sixth axis of the robot hand, each of which are oriented perpendicular to the preceding axis, and intersect one another at a point.

A safety coupling 7 is disposed on the robot flange, which is triggered actively or passively when a predefined shearing force is exceeded. In a not shown variation, the safety coupling can be omitted.

A six-axis force/torque sensor 5 is disposed on the safety coupling, or the robot flange, respectively, for detecting forces in a plug-in direction, indicated by a movement arrow in FIG. 1, orthogonal forces perpendicular thereto, as well as torques about rotational axes parallel to the forces, and is connected to the robot control 1.1 for signal transmission, as is indicated in FIG. 1 by a dot and dash line.

A plug 4.1 is attached to the force/torque sensor, such as a combination plug type 2, for example, which is connected to the mating plug 4.2 to form a releasable electric plug-in connection for charging the power storage unit of the motor vehicle, and has an electrical connection via a power supply cable 3.1 to a power source 3.2, which communicates with the control 1.1. The control 1.1 allows the power source 3.2 to supply current to the plug 4.1, as long as the robot 1 is located at the charging pose depicted in FIG. 1, within a predefined tolerance range, the force/torque sensor does not detect any shearing forces perpendicular to the plug-in direction, which exceed a predefined threshold value, and the force/torque sensor detects a sufficiently strong pressing force in the plug-in direction. In this manner, the plug 4.1 is not supplied with current when not used for charging, and when the plug-in connection is disengaged or is disengaging.

A CCD camera 6 is attached to the robot flange, which detects a region in the plug-in direction in front of the plug 4.1, and is connected to the control such signals can be transmitted.

FIG. 2 illustrates the sequence of a method according to one embodiment of the present invention, as it can be executed, in particular by the charging station explained in reference to FIG. 1.

In a step S10, the robot 1 guided by the control 1.1 positions the CCD camera 6 in the region of the tank opening, after the vehicle 2 has been driven into position and parked, and the tank opening is opened. The control 1.1 evaluates the camera image and thus determines the position of the mating plug 4.2.

In a step S20 the robot 1 guided by the control 1.1 positions the plug 4.1 in alignment with the mating plug and at a spacing thereto, based on the position thereof determined in this manner. The control can control the robot thereby in a position-regulated manner.

In a step S30 the robot 1 controlled by the control 1.1 plugs the plug 4.1 in a force-regulated manner into the mating plug 4.2. In doing so the force/torque sensor 5 detects the forces acting on the plug 4.1 in the plug-in direction and perpendicular thereto. The robot 1 controlled by the control 1.1 displaces the plug 4.1 in a position-regulated manner, wherein a force-regulation is superimposed thereon, which stops the movement in the plug-in direction when a predefined plug-in force has been reached. In one plane, or two orthogonal directions perpendicular to the plug-in direction, respectively, the robot 1, or the robot-guided plug 4.1 is force-regulated such that the plug 4.1 compensates for a reaction force, which acts on the plug 4.1 when the contact between the plug 4.1 and the mating plug 4.2 is offset or is not sufficiently aligned, and thus is oriented such that it is aligned with the mating plug. The same applies to torques about two or three orthogonal axes, of which one can be oriented, in particular, parallel or perpendicular to the plug-in direction; thus, the control 1.1 can rotate the robot-guided plug 4.1, for example due to the reaction forces, about an axis perpendicular to the drawing plane of FIG. 1, until its orientation is sufficiently aligned with the mating plug 4.2.

In a step S40 the control 1.1 enables a charging of the power storage unit of the vehicle by the power source 3.2, or commands this to provide the plug 4.1 with current. During the charging, forces determined by the force sensor 5 are stored and evaluated by the control 1.1, which forms a control, storage and evaluation means as set forth in the present invention.

In particular, the course of a force in the plug-in direction and/or perpendicular thereto can be stored and compared with previous forces, in order, for example, to evaluate wear to the plug-in connection. Additionally or alternatively, the release of the providing of current can depend on whether a sufficient force acts on the plug 4.1 in the plug-in direction during the charging for engaging the electric plug-in connection securely, and no excessive forces act on the plug 4.1 perpendicular to this plug-in direction, which attempt to disengage the plug-in connection, for example, due to an unintentional rolling away of the vehicle 2.

Additionally or alternatively, a connection target path can be adjusted in step S40. If, for example, the force in the plug-in direction reaches a predefined threshold value, based on the pre-positioning, with a specific insertion motion in the plug-in direction, this insertion motion, plus, if applicable, a predefined impact, can be predefined as the target insertion motion for the next connection or plug-in procedure, and the connection target path thus can be optimized. Additionally or alternatively, a release path, along which the robot 1 pulls the robot-guided plug 4.1 from the mating plug 4.2 when the charging is complete, can be adjusted based on the forces detected during the connection and/or during the charging. If, for example, the robot must compensate for these forces in a direction in a force-regulated manner during the connecting, the target releasing path can be modified in this direction accordingly.

If the charging is complete, the robot 1 guided by the control 1.1 releases the plug-in connection in a step S50, and pulls the plug 4.1 out of the mating plug 4.2 along a, possibly modified, release path.

In a further development that is not depicted, the robot 1 can have a gripper on its flange, in particular a magnetic or vacuum gripper, for opening a tank lid on the tank opening prior to step S10, and/or for closing the lid after step S50.

### REFERENCE SYMBOL LIST

1 robot
1.1 (robot) control (control, storage and evaluation means)
2 vehicle (body)
3.1 power line
3.2 power source
4.1 plug
4.2 mating plug
5 force/torque sensor (force detection means)
6 CCD camera (position detection means)
7 safety coupling

1-14. (canceled)

15. A charging system for a motor vehicle, in particular a passenger car, comprising:
a robot having a controller;
a force detection means; and
a robot-guided plug attached to the robot;
wherein the plug is configured to establish a releasable plug-in connection with a mating plug of the motor vehicle, for charging an electric power storage unit of the motor vehicle; and
wherein the controller communicates with the force detection means, and actuates the robot to connect the robot-guided plug to the mating plug based on a force determined by the force detection means.

16. The charging system of claim 15, further comprising:
a position detection means for determining a position of the mating plug;
wherein the controller is configured to communicate with the position detection means and to pre-position the robot-guided plug based on a position of the mating plug determined by the position detection means.

17. The charging system of claim 16, wherein the position detection means is a robot-guided position detection means.

18. The charging system according to claim 15, further comprising a storage and/or evaluation means for storing and/or evaluating a force determined by the force detection means.

19. The charging system according to claim 18, wherein the storage and/or evaluation means evaluates and/or adjusts at least one of:
the plug-in connection;
a connecting and/or releasing path; or
a charging position of the robot-guided plug.

20. The charging system of claim 15, further comprising a safety coupling disposed between the robot-guided plug and the robot.

21. The charging system of claim 15, wherein the controller executes a charging of a power storage unit of the motor vehicle via the robot-guided plug dependent on a release thereof by the controller.

22. The charging system of claim 15, further comprising a robot-guided gripper adapted to open and/or close a tank lid on the motor vehicle.

23. A method for electrical charging of a motor vehicle using a charging system including a robot having a controller, a force detection means, and a robot-guided plug coupled with the robot, the method comprising:
determining with the force detection means a force acting on the robot-guided plug; and
actuating the robot with the controller to connect the robot-guided plug to a mating plug of the motor vehicle based on the force determined by the force detection means.

24. The method of claim 23, further comprising:
determining a position of the mating plug with a position detection means; and
pre-positioning the robot-guided plug with the controller based on a position of the mating plug determined by the position detection means.

25. The method of claim 24, wherein the position detection means is a robot-guided position detection means.

26. The method of claim 23, further comprising:
at least one of storing or evaluating the force determined by the force detection means by a storage and/or evaluation means.

27. The method of claim 23, further comprising:
evaluating and/or adjusting, with the storage and/or evaluation means, at least one of:
the plug-in connection,
a connecting and/or releasing path, or
a charging position of the robot-guided plug.

28. The method of claim 23, wherein charging of the power storage unit is executed dependent on a release by the controller.

29. A computer program product, comprising:
a non-transitory computer-readable medium;
program code stored on the non-transitory computer-readable medium and configured to charge of a motor vehicle using a charging system including a robot having a controller, a force detection means, and a robot-guided plug coupled with the robot by:
determining with the force detection means a force acting on the robot-guided plug, and
actuating the robot with the controller to connect the robot-guided plug to a mating plug of the motor vehicle based on the force determined by the force detection means.
